(19) United States
(12) Patent Application Publication
(10) Pub. No.: US 2013/0113771 A1
(43) Pub. Date: May 9, 2013

(54) DISPLAY DRIVE WAVEFORM FOR WRITING IDENTICAL DATA

(71) Applicants: Mark M. Todorovich, San Diego, CA (US); Nao S. Chuei, San Mateo, CA (US)

(72) Inventors: Mark M. Todorovich, San Diego, CA (US); Nao S. Chuei, San Mateo, CA (US)

(73) Assignee: QUALCOMM MEMS Technologies, Inc., San Diego, CA (US)

(21) Appl. No.: 13/290,966

(22) Filed: Nov. 7, 2011

(51) Int. Cl. G09G 5/00

(52) U.S. Cl. 345/211

(57) ABSTRACT

This disclosure provides systems, methods and apparatus, including computer programs encoded on computer storage media, for alternating the polarity of a voltage across a display element. In one aspect, a display element is maintained in a current state following an alternation of polarity. A driving signal waveform is transitioned from a hold voltage of a first polarity substantially directly to a write voltage of a second polarity, and transitioned substantially directly from the write voltage of the second polarity to a hold voltage of the second polarity.

### TECHNICAL FIELD

This disclosure relates to systems and methods for maintaining a current state of a display element during an alternation of polarity of a voltage across the display element.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

In some implementations of interferometric modulator systems, in order to avoid a build up of charge in the electromechanical system components, the polarity of the voltage applied to certain electrodes is switched at certain times. For example, a MEMS component which has a positive polarity potential difference is switched to a negative polarity potential difference in order to reduce the amount of charge built up in the component. Driving waveforms for transitioning the polarity of the voltage applied conventionally include a clearing pulse (such as at a ground voltage) for clearing the display elements.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus for driving a display, the display including one or more lines of display elements. The apparatus includes a common driver, a segment driver; and a controller. The controller is configured to control the common driver and the segment driver such that for at least some lines where substantially identical image data as is already written to the line of display elements is written again in an immediately subsequent frame with a subsequent write polarity opposite of a current hold polarity of the line of display elements, the common driver applies a hold voltage of a first polarity to a common line of the line of display elements, transitions the common line substantially directly to a write voltage of a second polarity, and transitions the common line substantially directly to a hold voltage of the second polarity. The write voltage of the second polarity may be greater than the hold voltage of the second polarity.

Another innovative aspect of the subject matter described in this disclosure can be implemented in a method of writing substantially identical image data as is already written to a line of display elements with a write polarity opposite of a current bias polarity of the line of display elements. The method includes applying a hold voltage of a first polarity to a common line of the line of display elements to maintain a current state for each of the display elements, transitioning the common line substantially directly to a write voltage of a second polarity, and transitioning the common line substantially directly to a bias voltage of the second polarity. The write voltage of the second polarity may be greater than the bias voltage of the second polarity.

Another innovative aspect of the subject matter described in this disclosure can be implemented in an apparatus for writing substantially identical image data as is already written to a line of display elements with a write polarity opposite of a current bias polarity of the line of display elements. The apparatus includes a common driver, a segment driver, and means for controlling the common driver and the segment driver such that when substantially identical image data as is already written to the line of display elements is written again in an immediately subsequent frame with a subsequent write polarity opposite of a current bias polarity of the line of display elements, then the common driver applies a hold voltage of a first polarity to the line of display elements to maintain a current state of each of the display elements, transitions substantially directly to a write voltage of a second polarity, and transitions substantially directly to a hold voltage of the second polarity. The write voltage of the second polarity being greater than the hold voltage of the second polarity.

Another innovative aspect of the subject matter described in this disclosure can be implemented in a computer program product for processing data for a program configured to write data to a display including a line of display elements. The computer program product includes a non-transitory computer-readable medium having stored thereon code such that when substantially identical image data as is already written to the line of display elements is written again in an immediately subsequent frame with a subsequent bias polarity opposite of a current bias polarity of the line of display element. The code causing processing circuitry to apply a hold voltage of a first polarity to a common line of the line of display elements to maintain a current state for each of the display elements, transition the common line substantially directly to a write voltage of a second polarity, and transition the common line substantially directly to a hold voltage of the second polarity. The write voltage of the second polarity may be greater than the hold voltage of the second polarity.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 illustrates a conventional driving waveform for transitioning from a first polarity to a second polarity and writing data to a display.

FIG. 10A illustrates driving waveforms for writing data to a display according to some implementations.

FIG. 10B shows an example of a system block diagram illustrating an electronic device incorporating a 3×3 interferometric modulator display including a selection unit for selecting from among a plurality of voltages according to some implementations.

FIG. 11 illustrates a flowchart for a method of writing data to a display.

FIGS. 12A and 12B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, hold voltages, address voltages, and segment voltages may be used which always produce the same polarity potential difference across two electrodes which are configured to actuate and release in EMS devices, such as interferometric modulators. In some other implementations, signals can be used which alternate the polarity of the potential difference of the across the electrodes. Alternation of the polarity across the electrodes (that is, alternation of the polarity of write procedures) may reduce or inhibit charge accumulation on the electrodes which could occur after repeated write operations of a single polarity. While the methods described herein can be used in the context of any EMS device with at least two or more electrodes configured to move relative to one another, the remaining discussion will focus on interferometric modulators having a movable electrode and a stationary electrode that serves as a pixel or subpixel in a display having an array of such modulators. Such an array may be arranged in rows and columns. In some implementations, modulators in a row share a common line.

In some implementations of a driving scheme for interferometric modulators, when new data is to be written to a row of interferometric modulators, segment lines apply an appropriate voltage to each modulator in the row in order to actuate or release each modulator in accordance with the data. Then a write pulse is driven on the common line for a time to actuate or release the modulators, after which the common line is held at a hold voltage. After a certain time, when data is to be updated on the line anew, this process is repeated. Often, the common line is held at a release voltage (for example, ground) for a period of time in order to release all actuated modulators prior to applying the new write pulse for the new data. As noted above, however, it can be useful to switch the polarity of the voltage applied to the modulators. In some implementations, the polarity is flipped at each frame. That is, each time new data is written to the modulators, the polarity can be flipped.

In a conventional driving scheme, the common line is held at the release voltage, whether new data is written to the modulators or not. The period of time at the release voltage may result in transitioning substantially all the modulators along the common line to the released state. As a result, the displayed image may include bright sections corresponding to the released modulators. If a dark area of the screen is being re-written with the same data, alternating the polarity may result in a undesired artifacts in the displayed image as all actuated modulators are unnecessarily released and then re-actuated.

During alternation of the polarity, in the case where the display data is to remain the same for the modulators, the state of the modulators following the alternation of polarity will be the same as the state of the modulators prior to the alternation of polarity. Therefore, releasing the modulators may not be necessary. According to some implementations, a write waveform transitions substantially directly from a hold voltage at a first polarity to the write voltage of a second polarity that is different than the first polarity, eliminating a clearing cycle during the polarity change.

Particular implementations of the subject matter described in this disclosure can be implemented to realize one or more of the following potential advantages. Undesirable visual artifacts which may be generated due to clearing of modulators prior to writing the data during the alternation of polarity may be reduced or eliminated. Similarly, the time for reversal of polarity can be reduced, thereby increasing frame rate.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

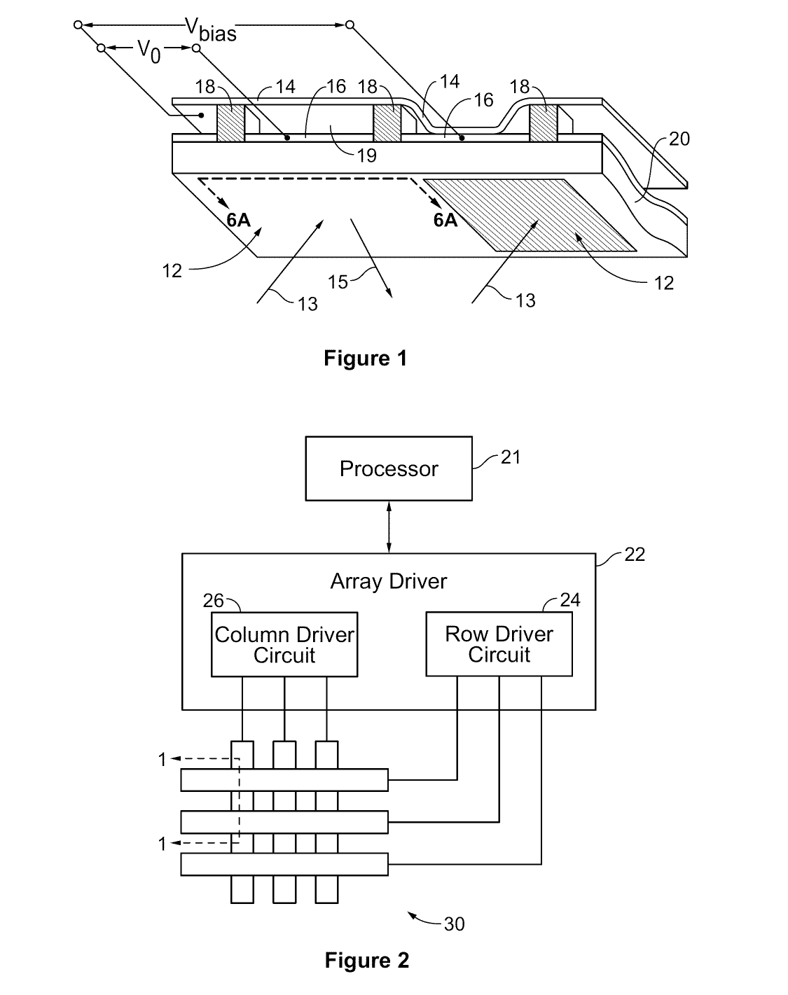

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

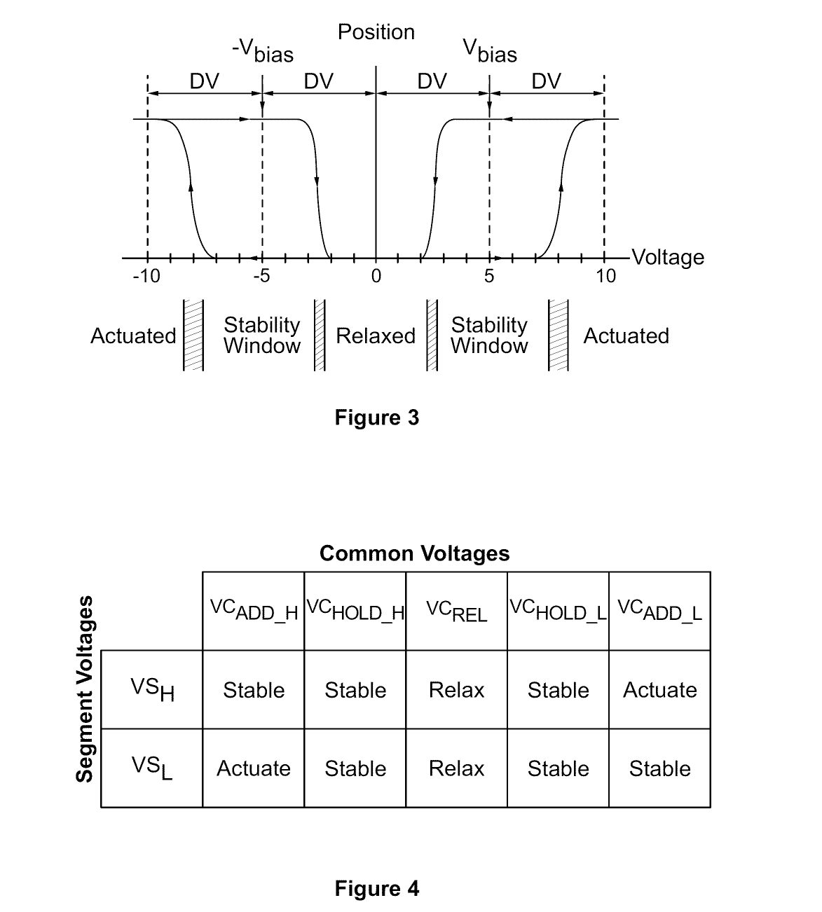

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

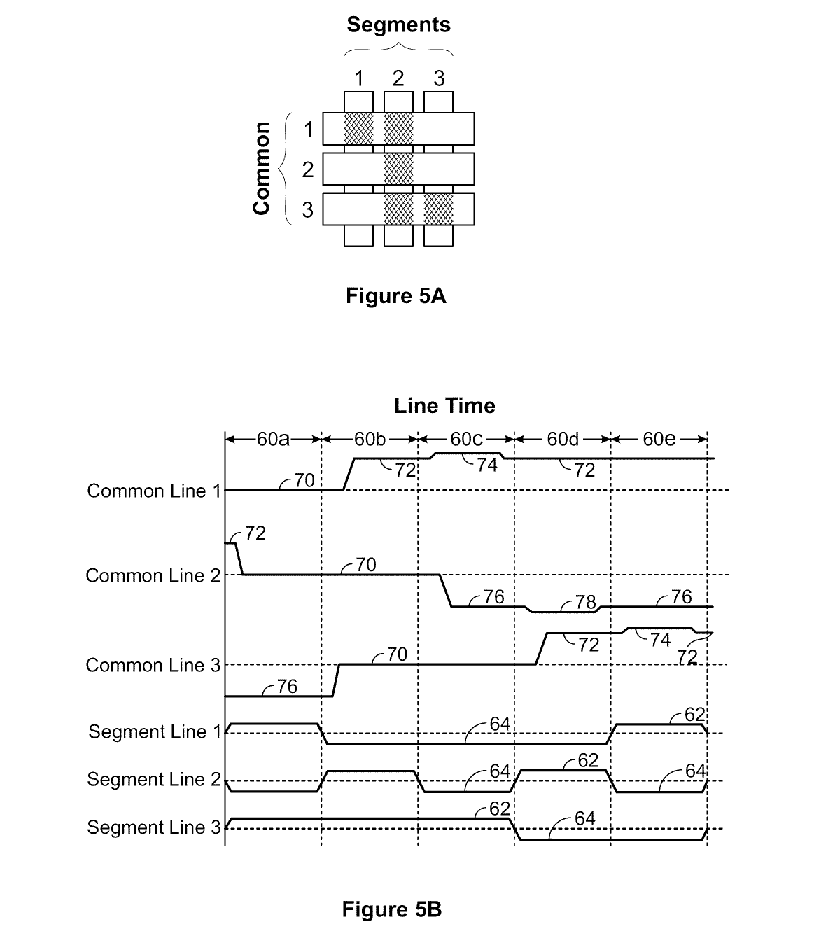

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

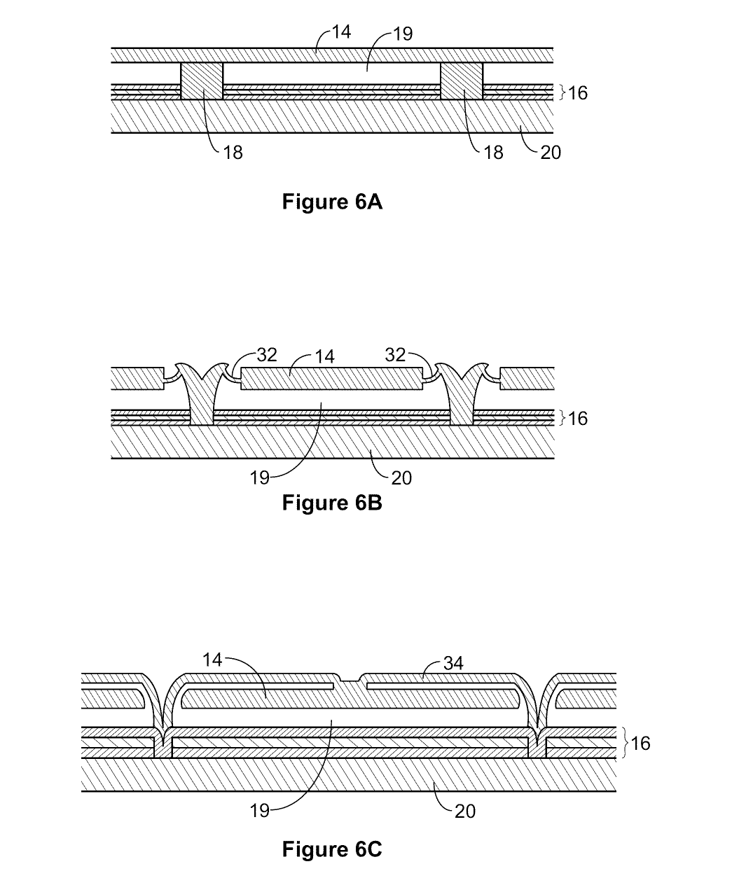

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

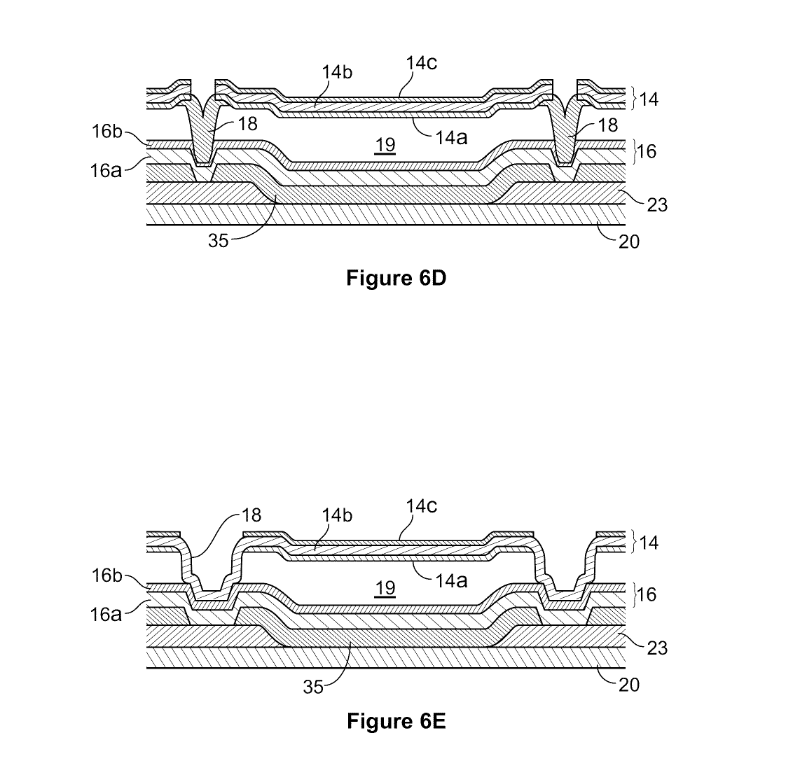

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L},the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

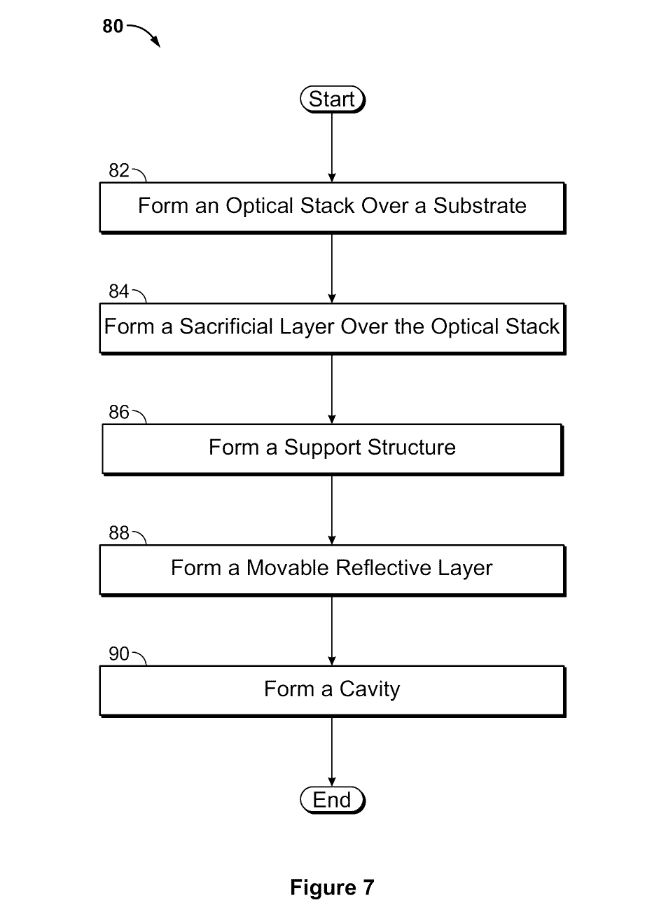

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

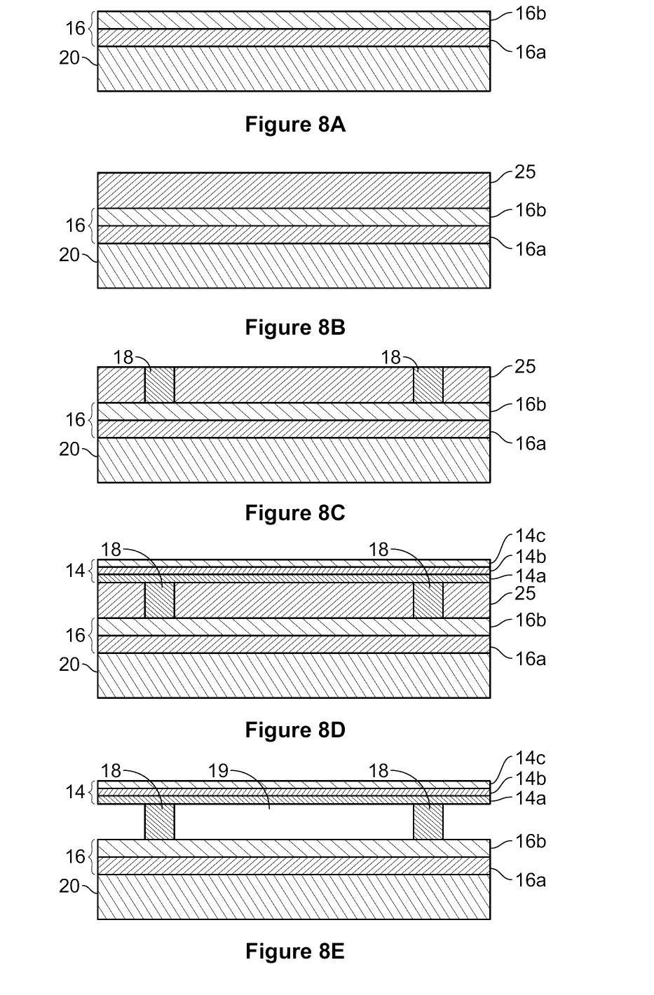

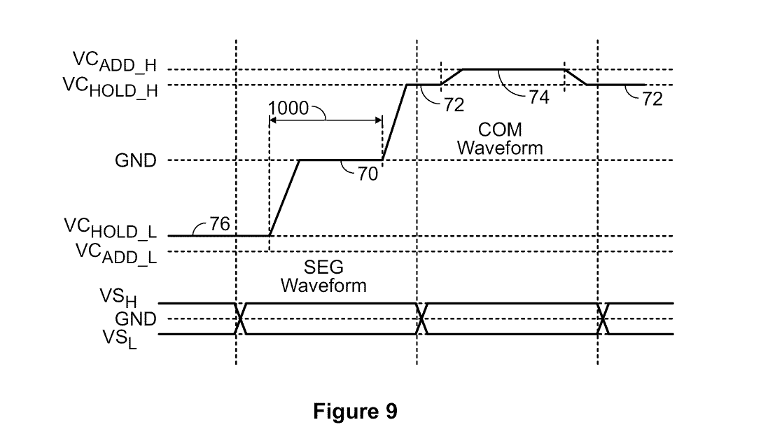

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As discussed above with reference to FIGS. 2-4, 5A, and 5B above, a display may include a plurality of common lines and a plurality of segment lines connected to an array of display elements (such as modulators). Driving waveforms may be applied to the segment lines by a segment driver (such as column driver circuit 26) and a common driver (such as row driver circuit 24) to write data to the display. A person/one having ordinary skill in the art will recognize that the segment driver may also correspond to the row driver circuit 24, and the common driver may correspond to the column driver circuit 26. For the purpose of the description below, the segment driver will described with reference to the column driver circuit 26, and the common driver will be described with reference to the row driver circuit 24.

Also as discussed above with reference to FIGS. 5A and 5B, image data may be written to a display including a plurality of display elements according to a series of common line write operations each corresponding to a line time 60. Following a write procedure of a first row of display elements, the display elements along the first row are placed in a hold state by application of a hold voltage (for example, high hold voltage 72 or low hold voltage 76) along the common line connected to the first row (such as Common 1 of FIG. 5A). The write procedure may then proceed to write data to the next row of display elements by application of a write voltage to the common line connected to the next row of display elements (such as Common 2 of FIG. 5A). Once all rows of the display have been written, the write procedure may then proceed to a next data write cycle for updating the first row of display elements with new data to write a new frame. In order to write new data to the first row of display elements, the display elements along the first row are transitioned to the released state first prior to application of the data being written to the first row. The process of releasing the display elements prior to writing new data may be used since the application of an address voltage (such as high address voltage 74 or low address voltage 78) during the line time will actuate released display elements for a first segment voltage, and hold released display elements in the released state for a second segment voltage, but cannot release actuated display elements under either segment voltage. That is, the application of any combination of the write voltage (such as a high address voltage 74, or a low address voltage 78) and segment voltage (such as high segment voltage 62 or low segment voltage 64) may correspond to voltage levels at which the potential difference across the display element will be outside of the range of potential differences for transitioning a display element to a released state as discussed above with reference to FIG. 3. For example, with returned reference to FIG. 3, a released state for a display element may correspond to a potential difference across the display element in the range of about −2V to about +2V. The hold voltage and the write voltage applied to the common line may have a magnitude that is greater than, for example, about 7V. The segment voltage may have a magnitude that is less than, for example, about 3V. As a result, any combination of common line voltage and segment line voltage that is applied to a display element may be outside of the range of potential differences that would transition the display element to a release state. Therefore, a voltage corresponding to the released state (such as 0V) is applied to the common line of the first row to change the state of actuated display elements along the first row to the released state prior to writing new data to the first row.

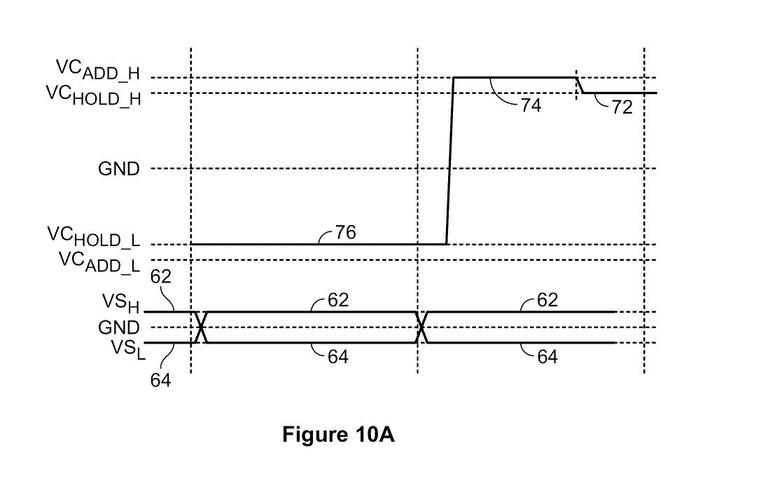

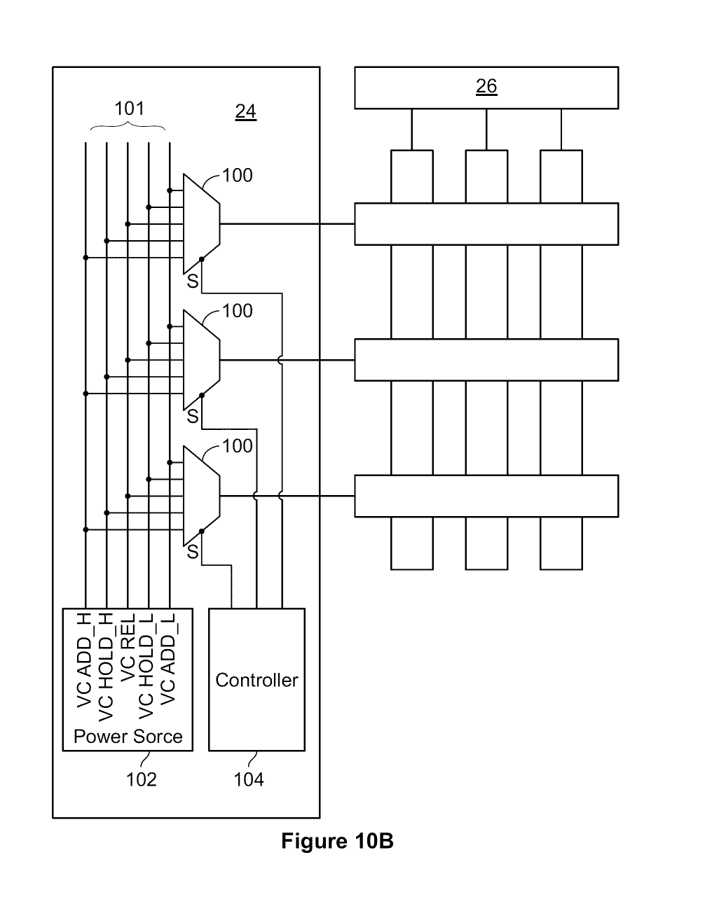

There are often periods of time when a static, unchanging image is being displayed. For example, the entire image may be identical between two subsequent frames. Also, two frames may differ, but a given line may contain identical data from a first frame to a second frame. It is possible in such cases to simply maintain the hold voltage on the common line(s), with no data writing taking place. However, to reduce charge build-up on the display elements, it can be beneficial to reverse the polarity of these hold voltages periodically. For example, the polarity of the write and/or hold voltage may be reversed at every frame. If no data is changing from the previous frame to the subsequent frame, the frame can be re-written with the same data, and the final hold voltage for each line can be the opposite polarity as the starting hold voltage. This can be done with the usual write procedure described above for changing images, but when the same data as is currently being displayed is to be written to a row of display elements, transitioning the display elements to the released state prior to writing the data for the row may not be necessary. That is, since display elements which are in the actuated state should remain in the actuated state when the same data is written to the row of display elements, it is not necessary to transition the display elements along the row to the released state prior to writing the same data. According to some implementations, a clearing pulse for transitioning the display elements along a row is eliminated when the row is being written with the same data as the previous write cycle. The waveform applied to the common line under these circumstances will be described in greater detail below with reference to FIGS. 9 and 10A.

FIG. 9 illustrates conventional driving waveforms for transitioning from a first polarity to a second polarity and writing data to a display. As illustrated in FIG. 9, a common line signal waveform may begin at a negative polarity hold voltage level VC_{HOLD}_{_{—}}_{L} as illustrated by low hold voltage 76. To reduce charge build up in the display elements, the row driver circuit 25 may be configured to alternate the polarity of display elements. During the alternation of polarity, the waveform may be transitioned from the low hold voltage 76 to a release voltage 70 (such as a ground voltage). A person/one having ordinary skill in the art will recognize that a release voltage 70 may correspond to other voltage levels based on a hysteresis response of the display element as discussed above with reference to FIG. 3.

The common line signal waveform may maintain the voltage at the release voltage level 70 for a period of time corresponding to the clearing pulse 1000 as illustrated in FIG. 9. The clearing pulse 1000 may correspond to a release period, or a period during which substantially all display elements along the common line are released. Following the clearing pulse 1000, the common line signal waveform is transitioned to the positive hold voltage VC_{HOLD}_{_{—}}_{H} as illustrated by high hold voltage 72. The common line signal waveform may then be configured to write data to a display by applying a write pulse having a high address voltage 74.

Since the alternation of polarity according to the conventional driving scheme always includes the clearing pulse 1000, substantially all display elements along the common line are set to the relaxed state prior to writing. This includes display elements which are in an actuated state and should remain in an actuated state following the alternation of polarity. This can be true for all actuated display elements in an image if the same image is being re-written, that is, when a previous frame and the immediately subsequent frame are identical. This can also be true where the frames are not identical in their entirety, but may be identical in certain regions. For example, one or more lines can be identical in both the previous and the immediately subsequent frame. For example, in cases where a dark portion of a display that should remain the same following the alternation of polarity, display elements which are in the actuated state prior to the alternation of polarity should remain in the actuated state. By clearing these display elements (for example, by maintaining the common line at a release voltage 70), artifacts in the displayed image may be produced. The artifacts may include light emitted and/or reflected from portions of the display for a brief period due to the release of display elements as a result of application of the release voltage level 70 during the clearing pulse 1000 just before re-writing the identical data.

Therefore, according to some aspects, a method of driving a display is described below which reduces or eliminates the effect of the above described visual artifacts. Some implementations of driving waveforms are described with reference to FIG. 10A. FIG. 10A illustrates driving waveforms for writing data to a display according to some implementations. The driving waveforms of FIG. 10A illustrate alternation of polarity from negative polarity to positive polarity across a display element by switching the polarity of a common line signal waveform. However, as discussed above, the driving waveforms may be similar but in opposite direction for the alternation of polarity from a positive polarity across the display element to the negative polarity across the display element.

FIG. 10B shows an example of a system block diagram illustrating an electronic device incorporating a 3×3 interferometric modulator display including a selection unit for selecting from among a plurality of voltages according to some implementations. As illustrated in FIG. 10B, a row driver circuit 24 may include a plurality of selection units 100 (such as multiplexers) each including a plurality of inputs configured to receive a plurality of voltage levels from a power source 102 through a plurality of voltage bus lines 101. As illustrated, each of the inputs to each selection unit 100 may be coupled to a voltage level through a connection to one of a plurality of voltage bus lines 101. For example, the voltage bus lines 101 may include bus lines providing voltages of VC_{ADD}_{_{—}}_{H}, VC_{HOLD}_{_{—}}_{H}, VC_{REL}, VC_{HOLD}_{_{—}}_{L}, and VC_{ADD}_{_{—}}_{L}. Each of the selection units 100 may include a select signal input such that the output of each selection unit 100 may be selected from the inputs to the selection unit 100 based on the select signal. A controller 104 may be configured to provide the select signal to each of the selection units 100 based on the data to be written to the display. The select signal for each multiplexer may be a three bit bus where the state of the three bits defines which input is coupled to the output. While illustrated as part of the row driver circuit 24, the controller 104 may also be provided external to the row driver circuit 24, and, in some implementations, may be configured to control both a row driver 24 and the column driver 26.

As illustrated in FIG. 10A, the alternation of polarity of the common line signal includes transitioning the common line signal waveform from a low hold voltage 76, represented by negative hold voltage VC_{HOLD}_{_{—}}_{L}, substantially directly to write voltage (such as a high address voltage 74), represented by positive write voltage VC_{ADD}_{_{—}}_{H}. This transition may correspond to changing the select input of one of the multiplexers 100 of FIG. 10B from a bit configuration corresponding to connecting the VC_{HOLD}_{_{—}}_{L} input to the output to a bit configuration corresponding to connecting the VC_{ADD}_{_{—}}_{H} input to the output. In conventional implementations, as shown in FIG. 9, a select input having a bit configuration corresponding to VC_{REL} would be applied in between these two. This intermediate select input application is not performed in some implementations.

Transitioning substantially directly to a write voltage of a second polarity may include completing the transition from the hold voltage of the first polarity to the write voltage of the second polarity in a transition time substantially less than the usual clearing pulse 1000 that is normally used to release the display elements along the line. For example, the transition time, which may be based in part on the switching speed of the selection unit 100, may be less than about 1/10^{th} of the release period. According to some implementations, the usual release period may be less than or equal to about 40 μs and the transition time may be less than or equal to about 4 μs. During the transition from the hold voltage of the first polarity to the write voltage of the second polarity, there still exists some period during which the common line voltage passes through the ground voltage level as illustrated in FIG. 10A. As a result, some display elements may still be released during the transition of the common line voltage. However, a majority of the display elements will not release during the transition due to the elimination of the clearing pulse 1000. Furthermore, any display elements that are released will be re-written back to an actuated state with application of the write voltage (such as the high address voltage 74 of FIG. 10A). The transition time may correspond to a time at which display elements that still transition to a non-actuated state are transitioned back to an actuated state without a visually discernable effect on the displayed image. Therefore, the visual effect of the display elements that are released during the transition is less likely to be discernable by a viewer of the image.

Following the high address voltage 74, the common line signal waveform is transitioned to a high hold voltage 72, represented by a positive hold voltage VC_{HOLD}_{_{—}}_{H}. The fundamental difference between the waveform illustrated in FIG. 10A and the waveform illustrated in FIG. 9 is the elimination of the clearing pulse 1000 of FIG. 9.

For a given display element, a response time of the display element to the application of a potential difference may be defined as a time that is equal to the time from the application of the potential difference to the display element to the time that half of the movable layer of the display element in an actuated state becomes separated from the optical stack. In some implementations, the switching speed of a selection unit 100 as illustrated in FIG. 10B may be faster than a response time of a display element to a change in voltage. In such a case, the common line signal waveform may transition substantially directly from a hold voltage of a first polarity to a hold voltage of the second polarity without releasing any display elements during the transition, even though the transition travels through the release window of the display elements. For example, if the switching speed of a selection unit 100 is fast enough that the period the voltage is within the release window is less than a response time of a display element, it is unlikely that a display element will inadvertently be released during a transition between opposite polarity voltages.

Through application of the waveform of FIG. 10A, display elements along the common line which are in an actuated state prior to the alternation of polarity are generally not transitioned to a non-actuated or relaxed state during the polarity switch. Additionally, the few display elements which are transitioned to a non-actuated or relaxed state during the switch are quickly transitioned back to the actuated state by application of the high address voltage 74 and corresponding low segment voltage 64. As a result, elimination of the clearing pulse (that is, eliminating the release voltage hold) when writing substantially identical image data to the line of display elements with a write polarity opposite of a current bias polarity can reduce visual artifacts in the displayed image.

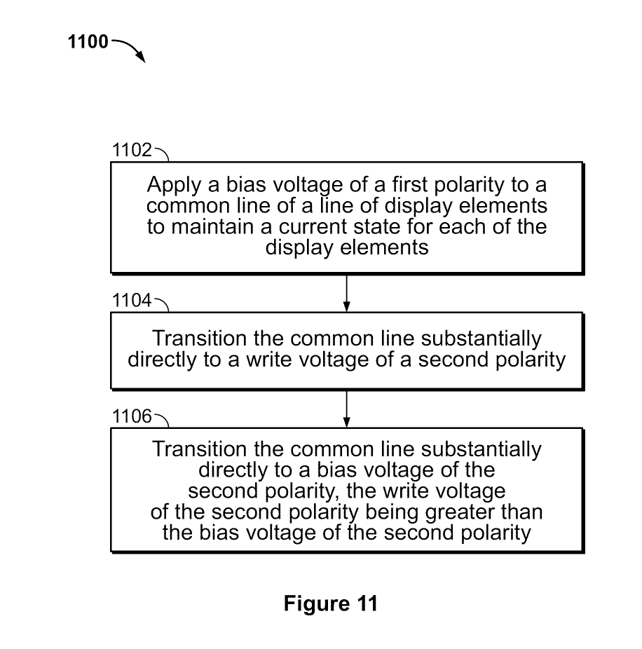

FIG. 11 illustrates a flowchart for a method of writing data to a display. The method 1200 includes applying a hold voltage of a first polarity to a common line of a line of display elements to maintain a current state for each of the display elements as illustrated in block 1202. For example, as discussed above with reference to FIG. 10A, a hold voltage corresponding to a negative polarity and having a low hold voltage 76 may be applied to the line of display elements along the common line. With reference to FIG. 10B, the common line for a row of display elements can be electrically connected to an input corresponding to a VC_{HOLD}_{_{—}}_{L} voltage level through a selection unit 100. The method may proceed to block 1204 for transitioning the common line substantially directly to a write voltage of a second polarity. In the example waveform of FIG. 10A, the common line may transition substantially directly from the low hold voltage 76 to the high address voltage 74. With reference to FIG. 10B, the common line for the row of display elements can be switched from VC_{HOLD}_{_{—}}_{L} immediately to VC_{ADD}_{_{—}}_{H} by the selection unit 100. The method may then proceed to block 1206, and a common line voltage may be transitioned substantially directly to a hold voltage of the second polarity. With reference to FIG. 10B, the common line for the row of display elements can be switched from VC_{ADD}_{_{—}}_{H} to VC_{HOLD}_{_{—}}_{H} by the selection unit 100. As illustrated in FIG. 10A above, for example, the common line voltage may be transitioned substantially directly from the high address voltage 74 to the high hold voltage 72. As illustrated in FIG. 10A, the write voltage (such as high address voltage 74) of the second polarity is greater than the hold voltage (such as high hold voltage 72) of the second polarity.

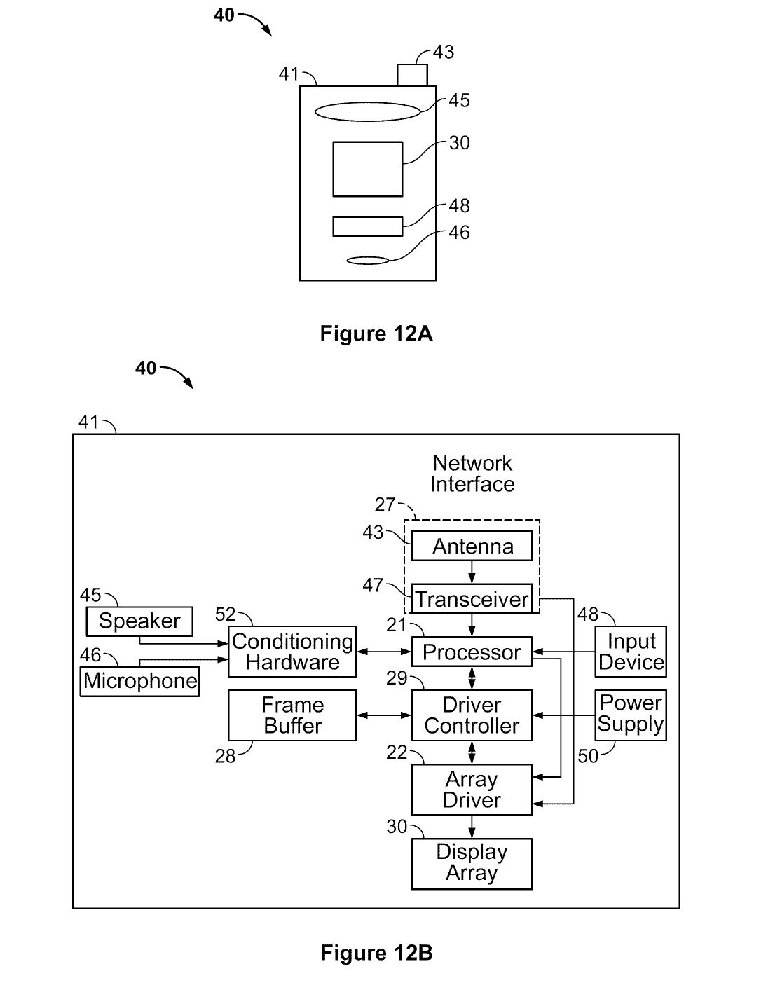

Although the above description is directed to a situation where a frame write procedure is being performed, and thus addressing voltages are being applied to write data during the line times, if the switch from one polarity to the other is fast enough to reliably maintain the state of all the display elements of the line in their current state the addressing pulse can be eliminated, and the transition can be from a hold voltage of one polarity directly to a hold voltage of the opposite polarity. In this case, as one example, the select input to a multiplexer 100 can be changed from a bit configuration corresponding to connecting the VC_{HOLD}_{_{—}}_{L} input to the output to a bit configuration corresponding to connecting the VC_{HOLD}_{_{—}}_{H} input to the output. FIGS. 12A and 12B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for driving a display, the display including one or more lines of display elements, the apparatus comprising:
a common driver;
a segment driver; and
a controller, wherein controller is configured to control the common driver and the segment driver such that for at least some lines where substantially identical image data as is already written to the line of display elements is written again in an immediately subsequent frame with a subsequent write polarity opposite of a current hold polarity of the line of display elements, the common driver:
applies a hold voltage of a first polarity to a common line of the line of display elements;
transitions the common line substantially directly to a write voltage of a second polarity; and
transitions the common line substantially directly to a hold voltage of the second polarity, wherein the write voltage of the second polarity is greater than the hold voltage of the second polarity.

2. The apparatus as recited in claim 1, wherein prior to a transition of the common line substantially directly to the write voltage, the controller is configured to control the segment driver to drive segment lines according to data to be written to the display elements of the common line.

3. The apparatus as recited in claim 2, wherein a difference in voltage between the write voltage and the segment voltage level across a display element is configured to actuate the display element along the line of display elements.

4. The apparatus as recited in claim 1, wherein the controller is further configured to control the common driver such that when new image data substantially different from image data as is already written to the line of display elements is written in a subsequent frame then the common driver drives actuated display elements in the line to a non-actuated state by applying a clearing pulse for a release period when writing the new image data, and wherein transitioning substantially directly to a write voltage of a second polarity includes completing a transition from the hold voltage of the first polarity to the write voltage of the second polarity in a transition time substantially less than the release period.

5. The apparatus as recited in claim 4, wherein the transition time is less than a response time of a display element.

6. The apparatus as recited in claim 4, wherein each display element is configured to be released within a release voltage range between a first release threshold voltage and a second release threshold voltage, and wherein the transition time includes a first transition from the first release threshold voltage within the release voltage range and a second transition time outside of the release voltage range, and wherein the first transition time is less than a response time of a display element.

7. The apparatus as recited in claim 4, wherein the release period is less than or equal to about 40 μs.

8. The apparatus as recited in claim 4, wherein the transition time corresponds to a time at which display elements transitioning to a non-actuated state are transitioned back to an actuated state without a visually discernable effect on the displayed image.

9. The apparatus as recited in claim 1, wherein transitioning substantially directly to a write voltage of a second polarity includes completing the transition at the output of the common driver in a transition time that is less than or equal to about 4 μs.

10. The apparatus as recited in claim 1, further comprising:
a display including a plurality of lines of the display elements;
a processor that is configured to communicate with the display, the processor being configured to process image data; and
a memory device that is configured to communicate with the processor.

11. The apparatus as recited in claim 10, further comprising:
an image source module configured to send the image data to the processor.

12. The apparatus as recited in claim 11, wherein the image source module includes at least one of a receiver, transceiver, and transmitter.

13. The apparatus as recited in claim 10, further comprising:
an input device configured to receive input data and to communicate the input data to the processor.

14. The apparatus as recited in claim 1, wherein the substantially identical image data includes an entire frame of substantially identical image data.

15. The apparatus as recited in claim 1, wherein the common driver includes a selection unit configured to select a voltage output from a plurality of voltage inputs, and wherein the controller is configured to switch the output of the selection unit from a voltage input of the first polarity directly to a voltage input of the second polarity.

16. A method of writing substantially identical image data as is already written to a line of display elements with a write polarity opposite of a current bias polarity of the line of display elements, the method comprising:
applying a hold voltage of a first polarity to a common line of the line of display elements to maintain a current state for each of the display elements;
transitioning the common line substantially directly to a write voltage of a second polarity; and
transitioning the common line substantially directly to a bias voltage of the second polarity, wherein the write voltage of the second polarity is greater than the bias voltage of the second polarity.

17. The method as recited in claim 16, wherein prior to a transition of the common line substantially directly to the write voltage, the method further comprises driving segment lines according to data to be written to the display elements of the common line.

18. The method as recited in claim 17, wherein a difference in voltage between the write voltage and the segment voltage level across a display element is configured to actuate the display element along the line of display elements.

19. The method as recited in claim 16, wherein when new image data substantially different from image data as is already written to the line of display elements is written in a subsequent frame then applying a clearing voltage for a release period when writing new image data, and wherein transitioning substantially directly to a write voltage of a second polarity includes completing a transition from the hold voltage of the first polarity to the write voltage of the second polarity in a transition time substantially less than the release period.

20. An apparatus for writing substantially identical image data as is already written to a line of display elements with a write polarity opposite of a current bias polarity of the line of display elements, the apparatus comprising:
a common driver;
a segment driver; and
means for controlling the common driver and the segment driver such that when substantially identical image data as is already written to the line of display elements is written again in an immediately subsequent frame with a subsequent write polarity opposite of a current bias polarity of the line of display elements, then the common driver applies a hold voltage of a first polarity to the line of display elements to maintain a current state of each of the display elements, transitions substantially directly to a write voltage of a second polarity, and transitions substantially directly to a hold voltage of the second polarity, wherein the write voltage of the second polarity is greater than the hold voltage of the second polarity.

21. The apparatus as recited in claim 20, wherein prior to a transition of the common line substantially directly to the write voltage, the segment driver is configured to drive segment lines according to data to be written to the display elements of the common line.

22. The apparatus as recited in claim 21, wherein a difference in voltage between the write voltage and the segment voltage level across a display element is configured to actuate the display element along the line of display elements.

23. The apparatus as recited in claim 20, when new image data substantially different from image data as is already written to the line of display elements is written in a subsequent frame then applying a clearing voltage for a release period when writing new image data, and wherein transitioning substantially directly to a write voltage of a second polarity includes completing the transition in a time substantially less than the release period.

24. A computer program product for processing data for a program configured to write data to a display including a line of display elements, the computer program product comprising:
a non-transitory computer-readable medium having stored thereon code such that when substantially identical image data as is already written to the line of display elements is written again in an immediately subsequent frame with a subsequent bias polarity opposite of a current bias polarity of the line of display elements, the code causes processing circuitry to:
apply a hold voltage of a first polarity to a common line of the line of display elements to maintain a current state for each of the display elements;
transition the common line substantially directly to a write voltage of a second polarity; and
transition the common line substantially directly to a hold voltage of the second polarity, wherein the write voltage of the second polarity is greater than the hold voltage of the second polarity.

25. The computer program product as recited in claim 24, wherein prior to a transition of the common line substantially directly to the write voltage, the computer program product further comprises code for causing processing circuitry to drive segment lines according to data to be written to the display elements of the common line.

26. The computer program product as recited in claim 25, wherein a difference in voltage between the write voltage and the segment voltage across a display element is configured to actuate the display element along the line of display elements.

27. The computer program product as recited in claim 24, wherein when new image data substantially different from image data as is already written to the line of display elements is written in a subsequent frame, then transitioning substantially directly to a write voltage of a second polarity includes completing the transition in a time substantially less than the release period.
